(19) United States
(12) Patent Application Publication
(10) Pub. No.: US 2025/0162940 A1
(43) Pub. Date: May 22, 2025

(54) USE OF INDUSTRIAL WASTE CLAYS FOR THE MANUFACTURE OF A SUPPLEMENTARY CEMENTITIOUS MATERIAL (SCM) AND METHOD FOR ITS MANUFACTURE

(71) Applicant: CEMENTOS ARGOS S.A., Medellin (CO)

(72) Inventors: Carlos Augusto OROZCO, Medellín (CO); Claudia Patricia RODRÍGUEZ HIDALGO, Medellín (CO)

(21) Appl. No.: 18/947,110

(22) Filed: Nov. 14, 2024

Related U.S. Application Data
(60) Provisional application No. 63/600,095, filed on Nov. 17, 2023.

(51) Int. Cl. C04B 14/10; B28C 1/16; B28C 1/22; C04B 7/43; C04B 20/00

(52) U.S. Cl. CPC C04B 14/106; B28C 1/16; B28C 1/227; C04B 7/434; C04B 20/008

(57) ABSTRACT

Uses of industrial waste clays for the manufacture of a supplementary cementitious material (SCM), wherein the industrial waste clays are kaolinitic clays selected from reject tails, cyclone tails, overburden/interburden from a refractory, ceramic, paper, oil or kaolin industries are described herein. A supplementary cementitious material (SCM) derived from calcined industrial waste clays wherein the obtained SCM maintain the same performance in comparison with other materials traditionally used and a method for manufacturing said SCM.

### TECHNICAL FIELD

The development describes a supplementary cementitious material (SCM) from calcined industrial waste clays and the use of industrial waste clays extracted from reject tails, cyclone tails, overburden/interburden from a refractory, ceramic, paper, oil, or kaolin industries in the preparation of supplementary cementitious material (SCM) and a method for its manufacture.

### TECHNICAL BACKGROUND

Due to the relatively high cost of raw materials, a new economic trend seeks to utilize industrial waste materials instead of using raw materials for the preparation of different products while maintaining the required properties.

For example, in the cement industry, supplementary cementitious materials (SCMs) are usually by-products or waste from other industries such as blast-furnace slags from steel production or fly ashes from coal-combustion for electricity production. However, since most conventional, high-quality SCMs are practically entirely consumed, SCMs will need to come from new alternative materials.

As part of the continuous search to find alternative materials as SCMs, industry, and researchers have worked on incorporating industrial waste. This also represents a promising alternative to mitigate pollution derived from the increasing amount of those residues that are being constantly produced with no control and then, discarded into regions, affecting the environment, soil, and water sources.

For example, U.S. Pat. No. 10,138,164 describes a SCM based on physico-chemically treated filter cake products extracted from dredged sediments, which can partially replace Portland cement clinker in conventional concrete applications with positive effects on sustainability.

In turn, patent WO2017/202849 describes a process for producing a SCM by burning a starting material containing dolomite and aluminum silicate under reducing conditions at a temperature ranging from 700° C. to 1100° C. or in the presence of a mineralizer.

The present disclosure describes supplementary cementitious material (SCM) from calcined industrial waste clays, particularly the use of industrial waste clays extracted from reject tails, cyclone tails, overburden/interburden from a refractory, ceramic, paper, oil, or kaolin industries in the preparation of such SCMs with equal performance to other traditionally used materials and, a method for its manufacture.

### BRIEF DESCRIPTION

The development first describes a supplementary cementitious material (SCM) derived from calcined industrial waste clays characterized by at least 30% amorphous phase; up to 15% kaolinite; up to 40% quartz; up to 15% iron oxides comprising hematite (α-Fe₂O₃), magnetite (Fe₃O₄), and maghemite (γ-Fe₂O₃); up to 15% mullite or sillimanite or spinel high-temperature minerals; and up to 10% companion material comprising [2:1 clay structure minerals] as illite & montmorillonite and non-clay minerals as mica, feldspars, anatase, rutile or calcite. Wherein the industrial waste clays are kaolinitic clays selected from reject tails, cyclone tails, and overburden/interburden from refractory, ceramic, paper, oil, or kaolin industries.

As a second aspect, it describes the use of industrial waste clays for the manufacture of a SCM, wherein the industrial waste clays are kaolinitic clays selected from reject tails, cyclone tails, and overburden/interburden from refractory, ceramic, paper, fiberglass, oil, or kaolin industries and said industrial waste clays are characterized by a raw kaolinite content greater than 25%, an aluminum content (Al₂O₃) greater than 17%, and a ferric oxide content (Fe₂O₃) of less than 15%.

As a third aspect, it describes a SCM derived from calcined industrial waste clays and 0.01 wt % to 20 wt % of one or more fillers selected from limestone, dolomite, silicate rocks, collected dust materials from the process of crushing rocks or mixtures thereof.

As the fourth aspect, it describes SCM derived from calcined industrial waste clays and 0.01 wt % to 2 wt % of one or more chemical admixtures selected from inorganic salts, alkanolamines, glycols, melamines, lignosulfonates, and polycarboxylates, or blend of those.

As fifth aspect, it describes SCM derived from calcined industrial waste clays having a 45 μm residue less than 34 wt %.

Finally, as a sixth aspect, it describes a method for producing SCM from calcined industrial waste clays wherein the industrial waste clays are kaolinitic clays selected from reject tails, cyclone tails, and overburden/interburden from a refractory, ceramic, paper, oil, or kaolin industries. The method comprise the steps of homogenizing and crushing industrial waste clays, wherein said industrial waste clays comprise a raw kaolinite content greater than 25%, an aluminum content (Al₂O₃) greater than 17% and a ferric oxide content (Fe₂O₃) of less than 15%; drying the homogenized and crushed industrial waste clays to reduce moisture content; calcining the dried industrial waste clays at a temperature between 600-1000° C.; and cooling the calcined industrial waste clays at a temperature up to 120° C. to obtain a SCM. In this aspect, the SCM resulting from this method is also encompassed in this development.

### BRIEF DESCRIPTION OF THE DRAWINGS

FIG. 1. Comparative evaluation of ASTM C 1012 mortar bar sulfate expansion, incorporating the SCM from industrial waste clay (20% SCM8), fly ash (20% FA), and slag (30% SL).

FIG. 2. Comparative evaluation of ASTM C 1202 rapid chloride test, incorporating the SCM from industrial waste clay (20% SCM8), fly ash (20% FA), and slag (30% SL).

FIG. 3. Comparative evaluation of ASTM C1567 bar expansion, incorporating the SCM from industrial waste clay (20% SCM8), fly ash (20% FA), and slag (35% Slag).

### DETAILED DESCRIPTION

The supplementary cementitious material (SCM) derived from calcined industrial waste clays aims to recycle and utilize some industrial waste clays, wherein the obtained SCM maintains the same performance in comparison with other materials traditionally used. Performance was analyzed in terms of strength activity index, replacement level, efficiency, reactivity, compressive strength, flowability, and durability.

### Characterization

Particularly, the development describes the use of industrial waste clays comprising a raw kaolinite content greater than 25%, an aluminum content (Al₂O₃) greater than 17% and a ferric oxide content (Fe₂O₃) of less than 15%, wherein said industrial waste clays are kaolinitic clays selected from reject tails, cyclone tails, and overburden/interburden from a refractory, ceramic, paper, oil or kaolin industries.

The SCM derived from calcined industrial waste clays are characterized by having an amorphous phase, kaolinite, quartz, iron oxides, mullite or sillimanite or spinel high temperature minerals, and companion material. Wherein spinel high-temperature minerals refer to a group of minerals that crystallize in the spinel structure and form at high temperatures during processes of calcination.

The SCM from calcined industrial waste clays is characterized by at least 30% amorphous phase; up to 15% kaolinite; up to 40% quartz; up to 15% iron oxides comprising hematite (α-Fe₂O₃), magnetite (Fe₃O₄), and maghemite (γ-Fe₂O₃); up to 15% of mullite or sillimanite or spinel high temperature minerals; and up to 10% a companion material comprising [2:1 clay structure mineral] as illite & montmorillonite and non-clay minerals as mica, feldspars, anatase, rutile or calcite.

The present development is also directed to a method for producing a SCM from calcined industrial waste clays comprising the steps of: (a) homogenizing and crushing industrial waste clays; (b) drying the homogenized and crushed industrial waste clays to reduce moisture content; (c) calcining the dried industrial waste clays; and (d) cooling the calcined industrial waste clays to obtain a SCM.

The term “industrial waste clays” as used herein refers to by-products or waste resulting from industrial activities carried out by refractory, ceramic, paper, oil, or kaolin industries. Particularly, it relates to kaolinitic clays extracted from reject tails, cyclone tails, and overburden/interburden from mining operations. These corresponds to residual material, leftover material, or material that was discarded, obtained after the extraction of valuable minerals and, for example, it does not meet the required criteria for further processing such as too coarse or too fine, presence of contaminants or low quality.

The industrial waste clays as defined herein are characterized by:
a raw kaolinite content greater than 25%, between 25% and 99%, between 30% and 90%, or preferably between 40% to 85%;
aluminum content (Al₂O₃) greater than 17%, between 17% and 60%, between 20% and 50%, or preferably between 22% to 48%; and
ferric oxide content (Fe₂O₃) of less than 15%, between 1% and 15%, between 4% and 13%, preferably between 6% to 12%.

Without being bound by theory, the inventors believe that industrial waste clay outside these characteristics would not be viable for thermal activation because their pozzolanic activity would be very low.

In one embodiment, the industrial waste clays are characterized by having agglomerated fine particles of less than 4 cm, less than 1 cm, less than 0.5 cm, less than 0.3 cm, less than 0.1 cm, preferably between 1 cm to 4 cm, 3 μm to 1 cm, 100 μm to 500 μm, 100 μm to 300 μm, or 3 μm to 100 μm. These particle sizes are needed for the correct calcination process allowing the required heat transfer between the kiln and the material.

The term “supplementary cementitious material” (SCM) as used herein refers to a material obtained from the calcination of industrial waste clays. When this material is added to Portland cement or concrete, it reacts with portlandite that is produced by alite or belite hydration in the presence of water to produce additional hydrate products.

Particularly, the SCM obtained from the calcination of industrial waste clays is characterized by:
at least 30% amorphous phase, preferably between 50% to 80%;
up to 15% kaolinite, preferably between 1% to 10%;
up to 40% quartz, preferably between 5% to 30%;
up to 15% iron oxides comprising hematite (α-Fe₂O₃), magnetite (Fe₃O₄), and maghemite (γ-Fe₂O₃), preferably between 1% to 6%;
up to 15% mullite or sillimanite, preferably between 0.5% to 5%; and
up to 10% companion material comprising [2:1 clay structure minerals] as illite & montmorillonite and non-clay minerals as mica, feldspars, anatase, rutile, or calcite, preferably between 7% to 10%.

In one embodiment, the SCM from calcined industrial waste clays is characterized by between 50% to 80% amorphous phase; between 1% to 10% kaolinite; between 5% to 30% quartz; between 1% to 6% iron oxides comprising hematite (α-Fe₂O₃), magnetite (Fe₃O₄), and maghemite (γ-Fe₂O₃); between 0.5% to 5% mullite or sillimanite or spinel high temperature minerals; and between 7% to 10% of a companion material comprising [2:1 clay structure mineral] as illite & montmorillonite and non-clay minerals as mica, feldspars, anatase, rutile, or calcite.

In one embodiment, the SCM obtained from the calcination of industrial waste clays further comprises one or more fillers between 0.01 wt % to 20 wt %, 0.01 wt % to 10 wt %, 1 wt % to 5 wt %, 5 wt % to 10 wt %, 10% to 15 wt % and 15 wt % to 20 wt %. Particularly, fillers are selected from limestone, dolomite, rocks formed by silicate minerals, and collected dust materials from the minerals processing mixture thereof. The fillers have a 45 μm residue of less than 34%, preferably 3-30%.

In other embodiment, the SCM obtained from the calcination of industrial waste clays further comprises one or more chemical admixtures between 0.01 wt % to 2 wt %, 1 wt % to 2 wt %, 0.5 wt % to 1 wt %, 0.1 wt % to 0.5 wt %, and 0.01 wt % to 0.1 wt %, approximately 0.05%. Particularly, chemical admixtures are selected from inorganic salts, alkanolamines, glycols, melamines, lignosulfonates, and polycarboxylates or a blend of those.

In particular, the SCM obtained from the calcination of industrial waste clays is characterized by having a 45 μm particle size between 15-30% w/w. Preferably, the SCM has a particle size wherein the 45 μm retain is up to 34% by weight.

Also, here is disclosed the use of a supplementary cementitious material (SCM) obtained from the calcination of industrial waste clays in cement and/or in concrete, that maintains the same performance as traditionally used materials.

In other aspect, the development describes a method for producing a supplementary cementitious material (SCM) from industrial waste clays, wherein each step is further described below:
Extraction of industrial waste clays: it consists of the collection of clays from reject tails, cyclone tails, and overburden/interburden from a refractory, ceramic, paper, oil, fiberglass, or kaolin industries. The waste clays are characterized by a raw kaolinite content greater than 25%, an aluminum content (Al₂O₃) greater than 17% and a ferric oxide content (Fe₂O₃) of less than 15%;
Drying and particle size reduction: in this step, if needed, the industrial waste clays are dried at a temperature between 150° C. and 300° C. until they reach a moisture content target. Furthermore, the particle size is reduced by any comminution means and the particle size and moisture content targets are both determined by the following calcination step. For example, for flash calcination, particle size reduction, and drying are aimed to obtain particle sizes less than 2 mm and 3% of moisture content, preferably between 0.15% to 1.5% moisture content.
Calcination: Calcination could take place in a flash calciner, a rotary kiln, or any hybrid between these concepts. For a flash calciner, the dried industrial waste clays are heated again to a temperature between 600° C. and 1000° C.; whereas if the calcination is in a rotary kiln a wide range of particle sizes are accepted from microns to millimeters as well as moisture content since drying and calcination could take place inside the kiln.
Cooling: the resulting calcined industrial waste clays are cooled to a temperature of up to 120° C. to obtain a supplementary cementitious material (SCM).

Details of the use of industrial waste clays for the manufacture of SCM and the method for producing such SCM are provided below:

### Extracting Industrial Waste Clays:

Industrial waste clays used for the manufacture of SCM are obtained from different sources, for example, from reject tails, cyclone tails, and overburden/interburden. Particularly, the industrial waste clays correspond to by-products or waste derived from the industrial activity of refractory, ceramic, paper, oil, or kaolin industries. The source of the industrial waste clays is usually open air, and the extraction and equipment required will depend on the moisture content of the clay which can vary from excavators for the ones with low moisture content i.e., <21% of moisture up to dredges for the wettest ones such as moisture >25%.

Industrial waste clays are kaolinitic clays that typically have different qualities, wherein the chemical variables of interest include the following: Al₂O₃, Fe₂O₃, and the amount of kaolinite. Particularly, for this development, the industrial waste clays extracted are kaolinitic clays comprising a raw kaolinite content greater than 25%, an aluminum content (Al₂O₃) greater than 17%, and a ferric oxide content (Fe₂O₃) of less than 15%.

Moisture variations of the industrial waste clays in the source will serve as a guide for subsequent drying and calcination operations. Drying is required on clays that are going to be calcined in flash calciner requiring moisture <3% and optional for kiln calcination if moisture is <35%

### Drying and Particle Size Reduction of the Industrial Waste Clays

The extracted industrial waste clays are dried by a flash drier, rotary dryer, tube-press, dry-crusher, or any other equipment that promotes the moisture loss from the industrial waste clay. Drying occurs as a consequence of increasing the clay temperature between 150° C.-300° C. The drying step continues until the extracted industrial waste clays have the moisture content required by the calcination step and method. Typically, the moisture content is less than 3%, or between 0.01% to 3% for flash calcination which should be done at the same time for operational efficiency reasons, as reducing particle fineness up to 2 mm. For rotary kilns, the moisture content could be up to 35%, preferably between 0.1% to 25% and industrial waste clay particles fed to the kiln could be up to 5 cm. Measurement of free moisture of the industrial waste clays can be done by regular methods, for example, by heating the sample to 120° C. and measuring its mass before and after heating, on a wet basis.

### Calcination

During calcination, chemisorbed water is released from the crystalline structure of the industrial waste clays (i.e., kaolinitic clays) and acquires an amorphous structure, providing calcined and activated clays. Calcination takes place between 600° C. to 1000° C., when the chemisorbed water in the clay structure is released, the aforementioned crystalline structure changes to an amorphous structure, and clay is activated. Said activation allows the oxides in the calcined clay (particularly aluminum and silicon) to react with the oxides (particularly calcium) from the clinker or lime. In a preferred embodiment, activation occurs between 800° C. to 1000° C. Calcination is performed in a flash calciner, a rotary kiln, or a fluidized bed.

In one embodiment, when calcination is performed in a rotary kiln or fluidized bed, the industrial waste clay (i.e., kaolinitic clays) is characterized by a particle size of less than 4 cm (40 mm) and a moisture content of less than 30%.

In another embodiment, calcination is performed in a flash calciner, and the industrial waste clay (i.e., kaolinitic clays) is characterized by a particle size of less than 2 mm and a moisture content of less than 3%.

### Cooling the Calcined Industrial Waste Clays

The hot product obtained from calcination is discharged into the cooler. At this stage, the temperature of the material is reduced to around 120° C. to obtain a supplementary cementitious material (SCM).

Additional steps could be included between or at the end of the steps already defined above to obtain other embodiments described herein. For example, an additional step of mixing is optionally included after the cooling step, wherein the resulting SCM derived from calcined industrial waste clays is mixed with a filler and/or a chemical admixture until a homogeneous mixture corresponding also to a supplementary cementitious material is obtained. If necessary, the SCM comprising calcined industrial waste clays and a filler and/or a chemical admixture like grinding aid is added to obtain a particle size of 45 μm.

### EXAMPLES

### Example 1. Characterization of Industrial Waste Clays

Industrial waste clays A5 to A8 were obtained from reject tails or interburden/overbunder from the mining process of kaolin.

Industrial waste clays are kaolinitic clays that were analyzed to determine their viability in the manufacture of SCMs. The viability was determined by the number of oxides, particularly Al₂O₃, Fe₂O₃ and kaolinite as shown in Table 1:

TABLE 1
Chemical analysis of industrial waste clays

| | Oxides (%) | | | | | | | | | | Kaolinite |
|---|---|---|---|---|---|---|---|---|---|---|---|
| | SiO₂ | Al₂O₃ | Fe₂O₃ | CaO | MgO | SO₃ | K₂O | Na₂O | TiO₂ | LOI | % |
| A5 | 33.0 | 47.0 | 1.6 | 0.1 | 0.1 | 0.3 | 0.3 | 0.2 | 2.3 | 15.0 | 65 |
| A6 | 33.4 | 35.8 | 1.7 | 2.3 | 0.1 | 0.2 | 0.1 | 1.4 | 2.0 | 22.7 | 72 |
| A7 | 61.0 | 19.7 | 6.7 | 0.1 | 0.8 | 0.1 | 4.1 | 0.1 | 1.2 | 5.2 | 25 |
| A8 | 41.4 | 39.8 | 1.0 | 0.1 | 0.1 | 0.0 | 0.1 | 0.1 | 1.7 | 15.5 | 80 |

Since industrial waste clays A5, A6, A7, and A8 contain the amounts of chemical variables of interest, namely, raw kaolinite content greater than 25%, aluminum content (Al₂O₃) greater than 17%, and a ferric oxide content (Fe₂O₃) of less than 15%, they are useful for manufacturing SCMs.

### Example 2. Method for Producing a Supplementary Cementitious Material (SCM) from Industrial Waste Clays with a Rotary Kiln or Fluidized Bed

Industrial waste clays A5, A6, and A8 described in Example 1 were calcined in a rotary kiln or fluidized bed and heated to a temperature between 600° C. and 1000° C. for 45 to 90 minutes. The resulting calcined industrial waste clays were cooled to a temperature to 100° C. to obtain supplementary cementitious materials SCM5, SCM6, and SCM8, corresponding to the calcination of industrial waste clays A5, A6, and A8, respectively.

### Example 3. Performance of the SCMs from Calcination of Industrial Waste Clay in Synergy with Cement

SCMs obtained according to Example 2 were tested at 20 wt % of the total cementitious material under ASTM C 311. Particularly, compressive strengths were measured at 7 and 28 days and were compared with 100% straight cement. Physical requirements by ASTM C 618 suggest results in terms of Strength Activity Index (SAI) higher than 75%

Particularly, SCM5, SCM6, and SCM8 were clays obtained from different sources of reject tails from kaolin mining all of them calcined in rotary kilns, the results obtained are as follows:

TABLE 2
Performance of SCMs obtained from
industrial waste clays with cement

| | | | Cs (MPa) | | SAI (%) | |
|---|---|---|---|---|---|---|
| | w/b | Flow (%) | 7 d | 28 d | 7 d | 28 d |
| SCM5 | 0.52 | 112.2 | 30.1 | 40.8 | 86% | 92% |
| SCM6 | 0.485 | 91.6 | 29.6 | 37.0 | 77% | 81% |
| SCM8 | 0.51 | 119.8 | 37.9 | 46.5 | 96% | 98% |

Results show that the SCMs obtained from the calcination of industrial waste clays have a strength activity index higher than the 75% requested by the standard, therefore they can be classified as a class-N Natural pozzolan and can be used as SCM.

### Example 4. Performance of the SCM from the Calcination of Industrial Waste Clay in Synergy with Concrete

SCM5 obtained according to Example 3 was tested in a concrete mixture between 3000-4000 psi with different SCM substitutions, to determine its replacement capacity. Particularly, SCM5 was tested in concrete with 20% substitution and compared to concrete with 20% fly ash substitution (Table 3).

TABLE 3
Performance of SCMs vs fly ash in concrete

| | | Dose of | | |
|---|---|---|---|---|
| | | Superplasticizer | R28 | |
| | Replacement | admixture | day | Efficiency |
| | (%) | (oz/cwt) | (psi) | (psi/lb) |
| Fly ash | 15% | 4.5 | 6860 | 9.94 |
| Fly ash | 20% | 2.5 | 6290 | 10.66 |
| Fly ash | 20% | N.A | 4384 | 8.27 |
| SCM5 | 20% | 4 | 6567 | 12.39 |

Results show there was an increase in superplasticizer dosage between 2 to 4 oz/cwt when SCMs obtained from industrial waste clays were included to reach the same slump value (reference slump).

In addition, SCMs show an increased efficiency of 2-3 psi/lb at 28 days in comparison with the efficiency for fly ashes. Results also show that SCMs obtained from industrial waste clays have a good reactivity, leading to cost reduction and/or lower cement content in the mixtures, guaranteeing the same performance but also reducing the carbon footprint.

### Example 5. Supplementary Cementitious Material (SCM) from Industrial Waste Clays with Fillers and Chemical Admixtures

SCMs were prepared from SCMs from calcination of industrial waste clays according to Examples 2 and 3 and fillers between 0.01% to 20% or chemical admixtures between 0.01% to 2%. The SCMs obtained are as follows:

TABLE 5
SCMs from industrial waste clays with
fillers and chemical admixtures

| | SCMs from | | | | |
|---|---|---|---|---|---|
| | industrial | | Filler | | Chemical |
| | waste clays | Filler | amount | Chemical | admixtures |
| | (%) | type | (%) | admixtures | (%) |
| SCM12 | 80 | Limestone | 20 | — | — |
| SCM14 | 100 | — | | Poly- | 0.05 |
| | | | | carboxylate | |

Compressive strength results with 20% of the SCMs and SAI determination according to ASTM C311 are as follows:

TABLE 6
Compressive strength results of SCMs from industrial
waste clays with fillers and chemical admixtures

| | | Flow | CS 7 d | CS 28 d | 7 d | CS 28 d |
|---|---|---|---|---|---|---|
| | w/b | (%) | (MPa) | (MPa) | (%) | (%) |
| SCM12 | 0.5 | 100 | 30.7 | 40.8 | 83% | 92% |
| SCM14 | 0.485 | 119 | 32.7 | 48.0 | 83% | 102% |

w/b is ratio between mix water and binder

Results show improvement not only in compressive strength but also in the flowability of the SCMs.

### Example 6. Durability Measurements of SCMs from Industrial Waste Clays

Several tests were conducted to assess the performance of SCMs obtained from the industrial waste clays as defined herein when replacing a percentage of the cement content.

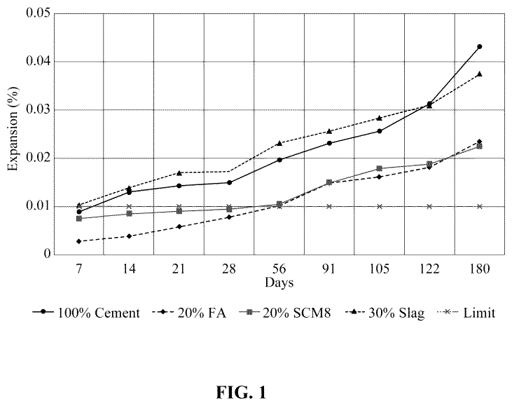

Specifically, the ASTM C 1012-Standard Test Method for Length Change of Hydraulic-Cement Mortars Exposed to a Sulfate Solution was performed on different formulations having a percentage of cement replaced by (or substituted with) the following supplementary cementitious materials: SCM8 as described herein and illustrated in Example 3, fly ash, and slag. The purpose of this test was to assess the percentage of expansion of the formulations over time. The results showed that SCM8 exhibited a favorable performance with a similar behavior to fly ash (FA) at the same amount of substitution. Moreover, it demonstrated lower expansion when compared to slag (SL) at 30% substitution as shown in FIG. 1. These results demonstrate the potential benefits of SCM8 in cement formulations and its suitability as a cement replacement material.

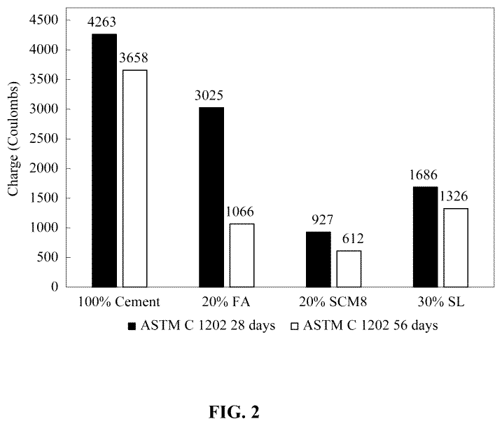

To assess the concrete microstructure permeability against aggressive agents such as chloride, which can affect the concrete performance, test ASTM C1202 for rapid chloride penetration was conducted. The purpose of this test was to compare the performance of different SCM such as Fly ash (20%), SCM 8 (20%) and Slag (30%) substitution at fixed water cement ratio and measured the charged passed during 6 hours test. As shown in FIG. 2, SCM8 exhibited superior resistance against chloride penetration at a 20% substitution rate, this performance surpassed fly ash (FA) with a 20% substitution rate, and slag (SL) with a 30% substitution rate. Results with lower charge represent a valuable addition to concrete formulations for enhanced resistance against chloride attack, contributing to improved concrete durability and extended lifetime.

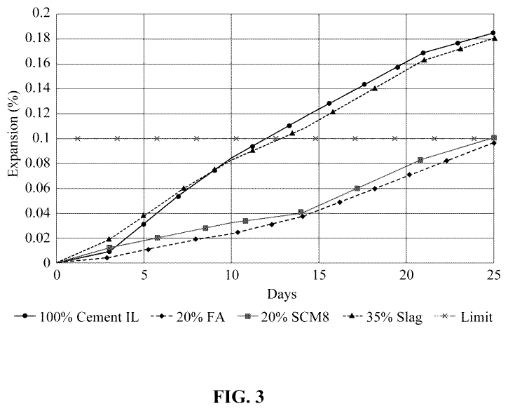

In order to evaluate the Alkali-Silica reaction, ASTM C 1567 (Standard Test Method for Determining the Potential Alkali-Silica Reactivity of Combinations of Cementitious Materials and Aggregate) using the accelerated mortar-bar method (FIG. 3) was performed. The primary objective of this test was to evaluate the mitigation SCMs effect when mixed with aggregates sensitive to alkali-silica reaction. Such reactivity could limit the use of SCM, since its expansion (when mixed with cementitious materials and water) could fracture the mortar. As illustrated in FIG. 3, SCM8 exhibited outstanding performance in mitigating the alkali-silica reactivity, which performed below the standard requirement at a replacement amount of 20%, showing a similar tendency to fly ash with the same substitution rate. Both the cement and slag, when substituted at 35%, failed the requirements of the test, overpassing the established limit at 16 days.

These results demonstrated that the SCMs resulting from industrial waste clays as developed and described herein provided outstanding potential for improving the durability and performance of concretes, especially in aggressive conditions such as exposure to sulfate and chloride environments. Furthermore, another important advantage is the possibility of using these cementitious materials with reactive aggregates, which cannot be used for straight cement concretes or materials with high alkali content. Notably, SCMs resulting from industrial waste clays exhibited similar performance in durability compared to the well-known and widely used in concrete fabrication, fly ash. In fact, the SCMs developed herein outperformed plain cement and slag in durability tests, which is also another well-established SCM used in the concrete industry.

1. A supplementary cementitious material (SCM) from calcined industrial waste clays characterized by:
at least 30% amorphous phase;
up to 15% kaolinite;
up to 40% quartz;
up to 15% iron oxides comprising hematite (α-Fe₂O₃), magnetite (Fe₃O₄), and maghemite (γ-Fe₂O₃);
up to 15% mullite or sillimanite; and
up to 10% companion material comprising [2:1 clay structure mineral] as illite & montmorillonite and non-clay minerals as mica, feldspars, anatase, rutile, or calcite;
wherein the industrial waste clays are kaolinitic clays selected from reject tails, cyclone tails, overburden/interburden from a refractory, ceramic, paper, oil or kaolin industries.

2. The SCM of claim 1, further comprising between 0.01 wt % to 20 wt % of one or more fillers.

3. The SCM of claim 2, wherein the one or more fillers are selected from the group consisting of limestone, dolomite, rocks formed by silicate minerals, collected dust materials from the process of crushing rocks or mixtures thereof.

4. The SCM of claim 1 further comprising between 0.01 wt % to 2 wt % of one or more chemical admixtures selected from inorganic salts, alkanolamines, glycols, melamines, lignosulfonates, and polycarboxylates, or a blended of those.

5. The SCM of claim 1, has a particle size wherein the 45 μm retain is up to 34% by weight.

6. Use of industrial waste clays for the manufacture of a supplementary cementitious material (SCM),
wherein the industrial waste clays are kaolinitic clays selected from reject tails, cyclone tails, overburden/interburden from a refractory, ceramic, paper, oil or kaolin industries;
wherein the kaolinitic clays are characterized by a raw kaolinite content greater than 25%, an aluminum content (Al₂O₃) greater than 17% and a ferric oxide content (Fe₂O₃) of less than 15%.

7. The use according to claim 6 wherein the kaolinitic clays are selected from reject tails, cyclone tails, overburden/interburden from refractory, ceramic, paper, oil or kaolin industries are characterized by fine particles sizes of less than 4 cm.

8. A method for producing a supplementary cementitious material (SCM) from calcined industrial waste clays comprising:
a) homogenizing and crushing industrial waste clays, wherein said industrial waste clays comprise a raw kaolinite content greater than 25%, an aluminum content (Al₂O₃) greater than 17% and a ferric oxide content (Fe₂O₃) of less than 15%;
b) drying the homogenized and crushed industrial waste clays to reduce moisture content;
c) calcining the dried industrial waste clays at a temperature between 600° C.-1000° C.; and
d) cooling the calcined industrial waste clays at a temperature up to 120° C., to obtain an SCM;
wherein the industrial waste clays are kaolinitic clays selected from reject tails, cyclone tails, overburden/interburden from a refractory, ceramic, paper, oil or kaolin industries.

9. The method of claim 8 wherein the kaolinitic clays are homogenized and crushed until a particle size less than 4 cm.

10. The method of claim 8 wherein in step b), the kaolinitic clays are dried until a moisture content of less than 30%.

11. The method of claim 8 wherein calcination is performed in a flash calciner, a rotary kiln, or a fluidized bed.

12. The method of claim 8, wherein calcination is performed in a rotary kiln or fluidized bed industrial waste clays are characterized by a particle size of less than 4 cm and a moisture content of less than 30%.

13. The method of claim 8, wherein calcination is performed in a flash calciner, and industrial waste clays are characterized by a particle size of less than 2 mm and a moisture content of less than 3%.

14. The method of claim 8, further including a mixing step wherein the SCM resulting from cooling step is mixed with a filler and/or a chemical admixture.
